(19) United States
(12) Patent Application Publication
(10) Pub. No.: US 2024/0328575 A1
(43) Pub. Date: Oct. 3, 2024

(54) CAST-IN SOFFIT CONNECTION RAIL

(71) Applicant: Peter Gutmann, Wahroonga (AU)

(72) Inventor: Peter Gutmann, Wahroonga (AU)

(21) Appl. No.: 18/622,942

(22) Filed: Mar. 31, 2024

(30) Foreign Application Priority Data
Apr. 1, 2023 (AU) 2023900932

(51) Int. Cl. F16M 13/02; B21B 1/085; E04B 9/18

(52) U.S. Cl. CPC F16M 13/02; B21B 1/085; E04B 9/18

(57) ABSTRACT

The present invention provides a rail inserted into the longitudinal joint of a pre-cast concrete or other type of pre-fabricated deck that is used as formwork to support concrete during construction of a suspended concrete slab. The cast-in soffit connector rail has a perforated vertical element that extends below the soffit level of the deck. The rail and the perforations are used for the connection of suspended elements like ceilings, cable trays, mechanical services etc. The cast-in soffit connector rail has a cross section profile that allows it to simply hook or wedge between the deck elements. The rail is used to not only simply, easily and quickly fix elements that need to be hung from the soffit, but it will also help to reduce the amount of slurry that typically falls between the deck joints during the concrete pour.

### TECHNICAL FIELD

The present invention provides a rail that is inserted into the longitudinal joint of a pre-cast concrete or other type of prefabricated deck, that is used as formwork to support concrete during construction of a suspended concrete slab. Said rail is used as a fixing support for the connection of hangers that support ceilings, cable trays, mechanical services and other items like sprinkler pipes and lights that are typically hung from the underside of a suspended structural floor slab.

### BACKGROUND OF THE INVENTION

With prefabrication and modular construction gaining in popularity, so is the use of precast &/or prefabricated decks as formwork to support suspended slabs, or as a suspended deck with no topping concrete. These prefabricated decks are often made from concrete in the form of Hollow core (or precast) slabs, timber or even steel, and used to create a working platform and formwork on which a concrete topping slab can be poured.

The primary issue that this invention addresses is the need to fix ceilings, cable trays and mechanical services including sprinkler pipes to the underside of the slab. This would normally be done by a mechanical fixing of some sort, like a dynabolt or chemical anchor drilled into the soffit of the deck. Or via clips that hook into the rebate of a metal formwork deck sheet. This is a time consuming and expensive method of fixing, it requires dangerous overhead work, with the added risk of the anchor &/or the structure failing.

A secondary problem is that concrete slurry typically escapes through the deck joints. This might occur when a topping or finishing slab is cast onto the deck.

Once inserted between the joints of the deck and the joint has been filled with a concrete mix or the deck has been cast with concrete, the “cast-in soffit connector rail” is ready for use allowing for the quick and safe installation of hangers to support the afore mentioned items.

### SUMMARY OF THE INVENTION

The invention is an elongate rail for use vertically between a plurality of prefabricated decks. In cross-section, the upper section or mid-section of the rail has at least one transverse profile along at least a portion of the elongate rail. The lower section of the rail has a number of perforated holes.

The transverse profile may enable the rail, in use, to be suspended between the decks. In this position, the perforated holes may be accessible beneath the decks.

Thus, in use, this invention may provide a perforated continuous longitudinal rail section to allow for a simple hook or bolted connection of any item to be suspended from the soffit.

The slurry escape or fall of material problem may be significantly reduced, if not eliminated by inserting the transverse profile into the joint before casting, creating a seal between the two deck elements.

There is no such cast in rail available on the market today, nor is the author aware of any similar patented item.

### BRIEF DESCRIPTION OF THE DRAWINGS

A detailed description of a preferred embodiment will follow, by way of example only, with reference to the accompanying figures of the drawing, in which:

FIG. 1: illustrates a cut away perspective of two hollow core concrete decks (1), the CAST-IN SOFFIT CONNECTION RAILS (2) along with the 4 possible rail section profiles (3, 4, 5 & 6). It also shows a typical hollow core deck joint profile and the location of the rail being supported by the recess or protrusions running along the length of the deck profile.

FIG. 2: illustrates a “Y” shaped Rail in section (3 & 5) with and without the added fold at its extremity.

FIG. 3: illustrates a Rail section (6) showing a punched out transverse element with and without the added fold at its extremity.

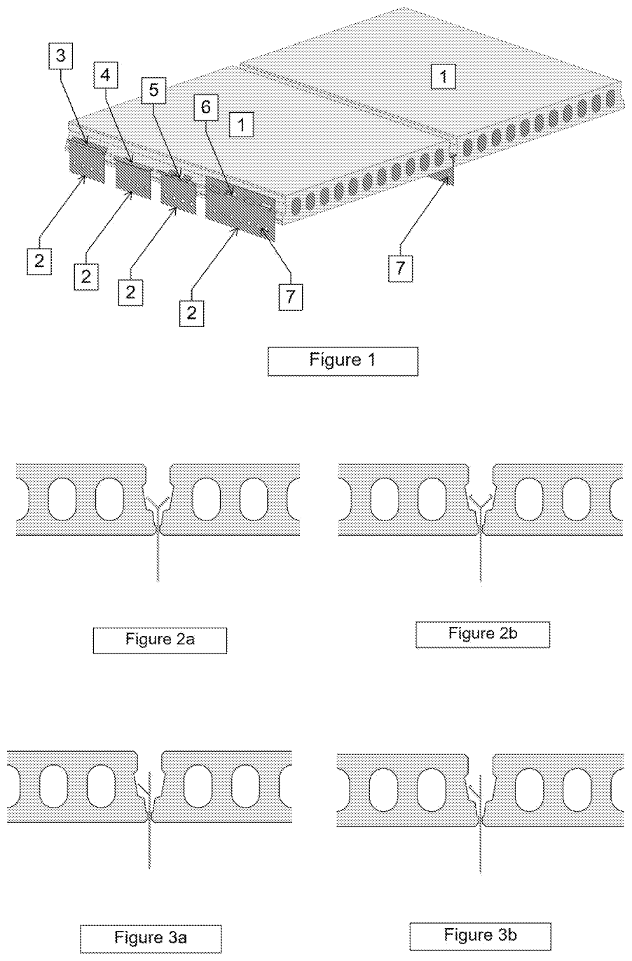

### DETAILED DESCRIPTION OF EMBODIMENTS

The invention is an elongated rail (2) that may be placed vertically between two prefabricated decking elements (1). In cross-section, the upper or mid-section of the rail (2) has a transverse profile (3, 4, 5, 6) running along the length of the elongate rail (2).

This transverse section (3, 4, 5, 6) may hook or wedge between the decks (1) and provides support to the vertical element (2). The lower protruding section of the vertical rail (2) has a number of holes (7) along its length that may be used as connection points for the hangers. Alternatively, the holes (7) need not run along the full length of the rail (2) but may be placed in any number or position on the lower section of the rail (2). The holes (7) may be equidistant or not. The hangers may support ceilings, cable trays, mechanical services and other items like sprinkler pipes and lights that are typically hung from the underside of a suspended structural floor slab.

The rail (2) can be made from a range of material including aluminium, steel, or plastic, or a combination of material. With the section profile (3, 4, 5, 6) being produced by folding, roll forming or punching flaps into flat coil.

The rail transverse section (3, 4, 5, 6) can take the shape of a ‘Y’ (3), ‘T’ (4), or similar, or combinations thereof, in cross-section. Alternatively, the transverse section may comprise flaps (5 & 6) produced by cutting or slitting and then folding back the material to create a transverse section or by punching and folding out an element in the upper or mid-section of the rail to create a transverse section. The flaps (5 & 6) may extend left and/or right of the vertical rail when viewed in cross-section. The transverse portion(s) act in use to support the vertical element (2).

The transverse section (3, 4, 5, 6) may also be provided with a gasket or seal to improve its ability to eliminate or reduce the amount of concrete slurry that passes through the deck joints.

The transverse section (3, 4, 5, 6) can be located at any depth within the supporting deck (1) or across the top edge of the supporting deck (1).

The transverse section (3, 4, 5, 6) or any similar section may also be provided with an additional fold at its extremity to further improve the rails pull out strength. As shown in FIGS. 2b & 3b.

1. An elongate rail for use vertically between a plurality of prefabricated decks, wherein:
the rail has an upper section, a mid-section and a lower section;
the upper section or mid-section of the rail, in cross-section, having at least one transverse profile along at least a portion of the rail; and
the lower section of the rail having a number of perforated holes.

2. An elongate rail as defined in claim 1, wherein:
the upper section or mid-section of the rail, in cross-section, has a plurality of transverse profiles.

3. An elongate rail as defined in claim 1 or 2, wherein:
the or each transverse profile, in cross-section, is of “Y”, “T”, or similar configuration.

4. An elongate rail as defined in claim 2, wherein:
the plurality of transverse profiles, in cross-section, are a combination of elements of “Y”, “T”, or similar configuration.

5. An elongate rail as defined in claim 2, wherein:
the plurality of transverse profiles comprises flaps extending left or right of the rail when viewed in cross-section.

6. An elongate rail as defined in claim 2, wherein:
the plurality of transverse profiles comprises flaps alternately extending left and right of the rail when viewed in cross-section.

7. An elongate rail as defined in claim 1 or 2, wherein:
the or each transverse profile is provided with a fold at its extremity.

8. An elongate rail as defined in any of claims 1 to 7, wherein:
the rail is made of aluminium, steel, plastic or combinations thereof.

9. An elongate rail as defined in any of claims 1 to 8, wherein:
the transverse profile, in use, is hooked or wedged between the decks.

10. An elongate rail as defined in any of claims 1 to 9, wherein:
the transverse profile is provided with a gasket or seal.

11. An elongate rail as defined in any of claims 1 to 10, wherein:
the lower section, in use, protrudes beneath the decks.

12. An elongate rail as defined in any of claims 1 to 11, wherein:
the perforated holes in the lower section provide connection points for hangers.

13. An elongate rail as defined in claim 12, wherein:
the hangers support ceilings, cable trays, mechanical services, sprinkler pipes, lights or the like.

14. A method of manufacturing an elongate rail, for use vertically between a plurality of prefabricated decks, comprising the steps of:
providing at least one transverse profile, in cross-section, along at least a portion of the rail at an upper section or mid-section thereof; and
providing a number of perforated holes in a lower section of the rail.

15. A method of manufacturing an elongate rail as claimed in claim 14, further comprising the steps of:
folding or roll-forming the rail to provide the transverse profile.

16. A method of manufacturing an elongate rail as claimed in claim 14, further comprising the steps of:
cutting or slitting elements of the rail to produce flaps and then folding back the flaps to create the transverse profile.

17. A method of manufacturing an elongate rail as claimed in claim 14, further comprising the steps of:
punching and folding elements of the rail to produce flaps to create the transverse profile.

18. A method of sealing a joint between a plurality of prefabricated decks, comprising the steps of:
inserting a transverse profile of an elongate rail, as claimed in any of claims 1 to 13, into the joint before casting.
